(19) United States
(12) Patent Application Publication
(10) Pub. No.: US 2014/0020301 A1
(43) Pub. Date: Jan. 23, 2014

(54) Automobile Door Edge Guard

(71) Applicant: Leone Joubert, Calgary (CA)

(72) Inventor: Leone Joubert, Calgary (CA)

(21) Appl. No.: 13/554,322

(22) Filed: Jul. 20, 2012

(51) Int. Cl. B60J 9/00

(52) U.S. Cl. 49/462

(57) ABSTRACT

An automobile door edge guard includes an elongated, unitary body member constructed entirely of a transparent and resilient material having a seat into which is received an edge portion of an automobile door edge for protecting the door edge and any surface against which the door edge may strike. A bulbous-shaped cushion portion projects outwardly from the body member and extends longitudinally and continuously therealong between opposed ends thereof. The body member has a thickness is less than the width of a gap between the edge of the automobile door and corresponding door jamb. A transparent adhesive secures the body to the automobile door.

### FIELD OF THE INVENTION

The present invention relates generally to door protectors, and more particularly, relating to door edge guard for application to the edge of an automobile door to protect the door edge and any surface against which the door edge may strike.

### BACKGROUND OF THE INVENTION

The use of automobile door protection devices that attach or otherwise secure to the edge of an automobile door are known in the art. U.S. Pat. No. 3,494,075 describes a resilient car door edge protector that secures to a longitudinal edge of an automobile door. Another type of an automobile door edge protector is described in U.S. Pat. No. 4,334,700, and in U.S. Pat. No. 5,062,665.

While these devices fulfill their respective, particular objective and requirements, the need remains for a new automobile door edge protector that is obscure, prevents non-uniform paint fading, and that is thin to permit utilization on doors having tight door jamb tolerances.

### SUMMARY OF THE INVENTION

Embodiments of the present invention addresses these needs by providing a door edge guard having an elongated, unitary body member constructed entirely of a transparent and resilient material. The body member includes a web portion, an inner leg portion extending from the web portion, an outer leg portion extending from the web portion in spaced relation and in the same general direction as the inner leg portion. The web portion, the inner leg portion, and the outer leg portion collectively defining a seat into which an edge of an automobile door is receivable with the inner leg portion disposed on an interior face of the automobile door, and with the outer leg portion disposed on an exterior face of the automobile door.

A bulbous-shaped cushion portion projects outwardly from the outer leg portion and extending longitudinally and continuously along the body member between opposed ends thereof and extending laterally between the juncture between the web portion and the outer leg portion and intermediate lateral position along the outer leg portion. A transparent, pressure sensitive adhesive is included on an interior surface of the body member for the purpose of securing the body member to the edge of the automobile door. The thickness of the web portion is less than the width of a gap between the edge of the automobile door and corresponding door jamb.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is preferred embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a side elevation view of an automobile with a door edge guard constructed in accordance with the principles of the present invention mounted to a door thereof;

FIG. 2 is an enlarged cross-sectional view taken along line 2-2 in FIG. 1; and

FIG. 3 is an enlarged side elevation view of a door edge guard constructed in accordance with the principles of the present invention.

### DETAILED DESCRIPTION OF THE INVENTION

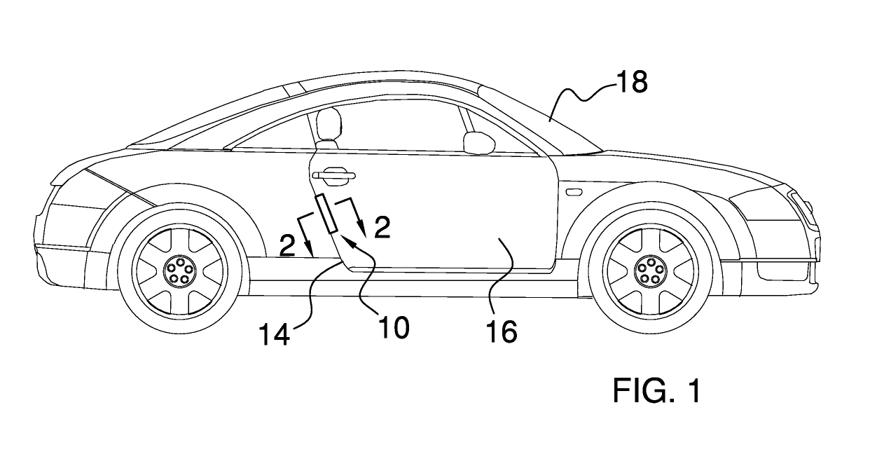

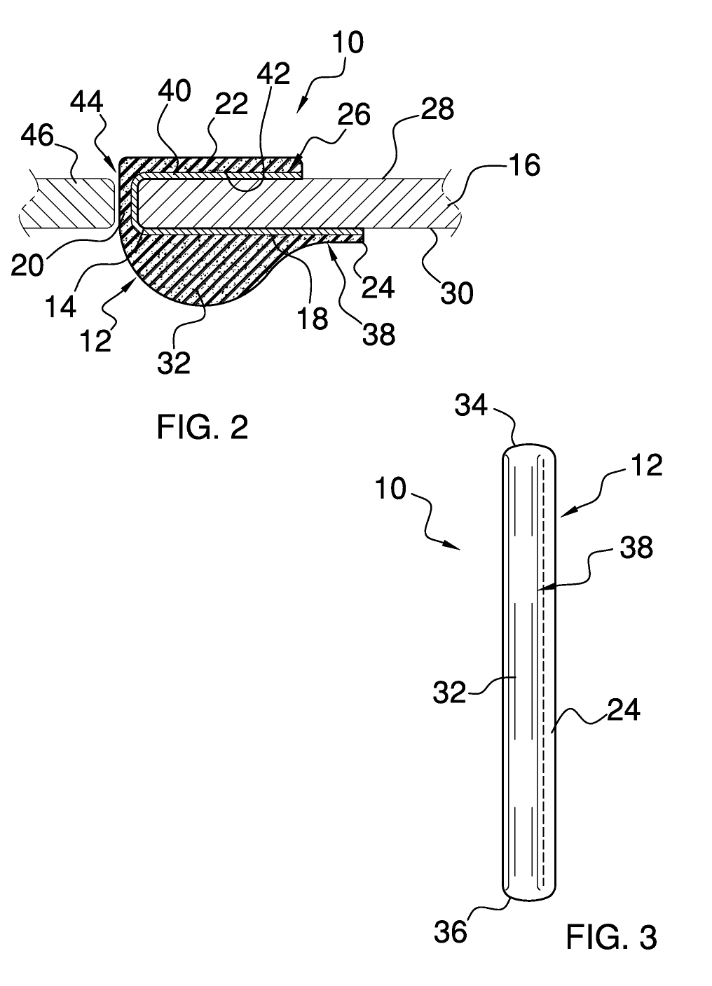

With reference now to FIGS. 1 through 3 of the drawings, a new specially designed automobile door edge guard embodying the principles and concepts of the present invention and generally designated by the reference number 10 will be described.

The door edge guard 10 has an elongated body member 12 that is mountable to an outward edge 14 of a door 16 of a conventional automobile 18. The door edge guard 10 is designed to attach to edge 14 and to extend along the outward most curved area of the door 16 which is the area most likely to contact surrounding objects when the door is opened. Body member 12 is of a unitary construction entirely made of a transparent and resilient material that permits the body member to flex and conform to the shape of edge 14 and to the shape of door 16 when attached thereto. The material constructing body member 12 being transparent obscures the presence of the door edge guard 10 on the door 16 by allowing the color of the automobile 18 to be visible through the door edge guard. The transparency also serves prevent non-uniform paint fading that otherwise would occur with an opaque material construction by blocking exposure to sun light, which upon removal of the door edge guard would leave a noticeably different color where the door guard was located.

The material must also be capable of absorbing shock upon impact and which bends and twists to permit mounting of the door guard on a door edge of an angular or sculpted contour, such as normally found on an automobile, without modification or cutting of the door guard. The material must also be weather resistant and retain its resiliency and flexibility over a wide range of weather and temperature conditions without hardening, cracking or otherwise loose its function.

The body member 12 includes a web portion 20, an inner leg portion 22 extending from the web portion and an outer leg portion 24 extending from the web portion in spaced relation and in the same general direction as the inner leg portion. The web portion 20, the inner leg portion 22, and the outer leg portion 24 collectively defining a seat 26 into which is received the edge 14 of the door 16 with inner leg portion disposed on an interior face or side 28 of the door, and with the outer leg portion disposed on an exterior face or side 30 of automobile door. In an embodiment, the body member 12 is about 6-inches in length as measured from end to end, and about 0.625-inches in width as measured between the outermost opposed edges.

The body member 12 further has a bulbous-shaped cushion portion 32 projecting outwardly from the outer leg portion 24 and extending longitudinally and continuously along the body member between opposed ends 34 and 36 thereof and extending laterally between the juncture of the web portion 14 and the outer leg portion and intermediate lateral position 38 along the outer leg portion.

A transparent, pressure sensitive adhesive 40 is disposed on an interior surface 42 of the body member 12 for the purpose of securing the body member to the edge of the automobile door. It is important the adhesive 40 is transparent so as not to defeat the purpose of the body member 12 being constructed of a transparent material. In an aspect, the adhesive 40 may extend continuously across the interior surface 42 or may be disposed along discrete locations as desired.

An important feature of the door edge guard 10 is found in the thickness of the web portion 20 being less than the width of a gap 44 disposed between the edge 14 of the automobile door 16 and corresponding door jamb 46, which permits the door to close without the door edge guard being pinched between the door and door jamb.

A number of embodiments of the present invention have been described. Nevertheless, it will be understood that various modifications may be made without departing from the spirit and scope of the invention. Accordingly, other embodiments are within the scope of the following claims.

1. A door edge guard for protecting an edge of an automobile door, the door edge guard comprising:
an elongated, unitary body member constructed entirely of a transparent and resilient material, said body having a web portion, an inner leg portion extending from said web portion, an outer leg portion extending from said web portion in spaced relation and in the same general direction as said inner leg portion, said web portion, said inner leg portion, and said outer leg portion collectively defining a seat into which the edge of the automobile door is receivable with said inner leg portion disposed on an interior face of the automobile door, and with said outer leg portion disposed on an exterior face of the automobile door;
said body member further having a bulbous-shaped cushion portion projecting outwardly from said outer leg portion and extending longitudinally and continuously along said body member between opposed ends thereof and extending from said web portion laterally along said outer leg portion and terminating an intermediate lateral position along said outer leg portion;
a transparent, pressure sensitive adhesive on an interior surface of said body member for the purpose of securing the body member to the edge of the automobile door; and
wherein the thickness of said web portion is less than the width of a gap between the edge of the automobile door and corresponding door jamb.

2. The door edge guard of claim 1, wherein said bulbous-shaped cushion portion is at least three-times the thickness of said web portion.

3. The door edge guard of claim 1, wherein said adhesive extends continuously across said interior surface of said body member.

4. The door edge guard of claim 1, wherein said body member has a length of about 6-inches.
